(19) United States
(12) Patent Application Publication
(10) Pub. No.: US 2019/0228420 A1
(43) Pub. Date: Jul. 25, 2019

(54) METHOD AND SYSTEM FOR VERIFYING MERCHANDISE AUTHENTICITY

(71) Applicant: DONGGUAN SUPEREYE NETWORK TECHNOLOGY CO., LTD., Dongguan City, Guangdong Province (CN)

(72) Inventor: QIRONG CAI, Dongguan City, Guangdong Province (CN)

(21) Appl. No.: 16/341,061

(22) PCT Filed: Feb. 28, 2017
(86) PCT No.: PCT/CN2017/075264

§ 371 Date: Apr. 10, 2019

(30) Foreign Application Priority Data
Oct. 10, 2016 (CN) 201610885344.4

(51) Int. Cl. G06Q 30/00; G06F 16/955

(52) U.S. Cl. CPC G06Q 30/0185; G06F 16/955

(57) ABSTRACT

The present invention is applicable in the field of anti-counterfeiting. Provided are a method and system for verifying merchandise authenticity. The method comprises: a merchandise supplier verification server receives a user-inputted merchandise identification code on an anti-counterfeiting label attached to a merchandise to be verified; the merchandise supplier verification server determines whether the user-inputted merchandise identification code is prestored; if yes, then displays on a user query page a label pattern corresponding to the anti-counterfeiting label corresponding to the user-inputted merchandise identification code before being delivered to a merchandise supplier and an anti-counterfeiting pattern corresponding to the prestored and user-inputted merchandise identification code, and a user compares the label pattern and the anti-counterfeiting pattern with a label pattern and the anti-counterfeiting pattern of the merchandise to be verified, thus verifying whether the merchandise is authentic. The present invention allows the determination of the authenticity of a merchandise.

### FIELD OF THE INVENTION

The present invention relates to the field of anti-counterfeiting, and especially a method and a system for verifying merchandise authenticity.

### BACKGROUND OF THE INVENTION

Anti-counterfeiting is a technique used to identify authenticity and prevent forgery, falsification and cloning. The most widely used anti-counterfeiting technology is textured anti-counterfeiting label. Textured anti-counterfeiting is a kind of anti-counterfeiting technology which uses stripe marks as anti-counterfeiting recognition mark. There are various stripe markings in nature, such as wood grain, Stone grain, ice grain, leaf pattern, and so on, which are random, unique, and can't be two exactly the same. Based this principle, anti-counterfeiting marks can be made from the material with clear texture, and each stripe mark from the marking material is photographed, numbered, archived and stored in an anti-counterfeiting database. Consumers can search files through the Internet, fax, and telephone for authenticating.

However, once the existing textured anti-counterfeiting labels are produced by label manufacturers, the anti-counterfeiting features have been fixed, and texture data stored by label manufacturers, which provides the illegal personnel with the opportunity to sell fake. Because the existing texture anti-counterfeiting label can only identify the label, there has been fake goods with a real label, and it cannot effectively prevent the reuse of the old label and the resale of the label.

The most implicit phenomenon in the industry today is that label supplier (or their executives, network administrators) resell labels to aid counterfeiting and the executives, technicians, and network administrators of the merchandise supplier take part in counterfeiting, for example:

a. labels manufactured by the label supplier are not all given to the merchandise supplier;

b. the label supplier verification system is maliciously increased illegal label data;

c. the merchandise supplier loses the anti-counterfeiting label, and the counterfeiters stick it on the fake goods; or

d. the merchandise supplier verification system is maliciously increased illegal label data.

The existing means for authenticating the object usually identifies whether the labels are genuine through the label supplier server. However, in the above circumstances, the labels identified are true, but the goods are actually counterfeit, so there is still a situation of counterfeit article with genuine labels.

### TECHNICAL PROBLEMS

An object of the present invention is to provide a method and a system for verifying merchandise authenticity, which aims to solve the problem of counterfeit article with a genuine label when authenticating a label on the object through the label supplier server using existing means.

### SOLUTION TO THE PROBLEMS

### Technical Solution

At a first aspect, the present invention provides a method for verifying merchandise authenticity, the method comprises steps of:
receiving a user-inputted merchandise identification code in an anti-counterfeiting label attached to a merchandise to be verified via a merchandise supplier verification serve, and each anti-counterfeiting label corresponding to one identification code;
determining via the merchandise supplier verification server whether the user-inputted merchandise identification code is prestored; if yes, then displaying on a user query page a label pattern of an anti-counterfeiting label corresponding to the user-inputted merchandise identification code before being delivered to a merchandise supplier and an anti-counterfeiting pattern prestored and corresponding to the user-inputted identification code, whereby the user can compare the label pattern and the anti-counterfeiting pattern respectively with a label pattern and an anti-counterfeiting pattern of the merchandise to be verified, and thus verify whether the merchandise is authentic; wherein the anti-counterfeiting pattern: is a label pattern of an anti-counterfeiting label after anti-counterfeiting treatment by the merchandise supplier which is delivered by the label supplier, or is constructed by an anti-counterfeiting label attached to a textured carrier together with a texture of the carrier, or is an anti-counterfeiting pattern on merchandise packaging; when the anti-counterfeiting pattern is an anti-counterfeiting pattern on merchandise packaging, the anti-counterfeiting pattern and/or label pattern on merchandise packaging are random.

Further, if the anti-counterfeiting pattern is a label pattern of an anti-counterfeiting label after anti-counterfeiting treatment by the merchandise supplier which is delivered by the label supplier, or is constructed by an anti-counterfeiting label attached to a textured carrier together with a texture of the carrier, then the anti-counterfeiting pattern corresponding to the user-inputted merchandise identification code is collected by the merchandise supplier, and is stored in the merchandise supplier verification server;

if the anti-counterfeiting pattern is an anti-counterfeiting pattern on merchandise packaging, the anti-counterfeiting pattern corresponding to the user-inputted merchandise identification code is collected by the merchandise supplier or a packaging supplier, and is stored in the merchandise supplier verification server;

the label pattern of an anti-counterfeiting label corresponding to the user-inputted merchandise identification code before being delivered to a merchandise supplier is pre-collected by the label supplier, and is stored in a label supplier verification server; the merchandise supplier verification server stores a link address corresponding to the label pattern provided by the label supplier verification server, or the merchandise supplier verification server stores the label pattern provided by the label supplier verification server, or if the merchandise supplier verification server determines that the merchandise identification code inputted by the user is prestored, the merchandise supplier verification server sends query instructions to the label supplier verification server, and then the label supplier verification server send the merchandise supplier verification server the prestored label pattern of an anti-counterfeiting label corresponding to the user-inputted merchandise identification code before being delivered to a merchandise supplier.

Further, the anti-counterfeiting label is printed with a verification password area for a verification password to be inputted when verifying authenticity of a merchandise with the anti-counterfeiting label through a server, a surface of the verification password area has a covering layer; the method further comprises a step of: receiving via the merchandise supplier verification server the user-inputted verification password in the anti-counterfeiting label attached to the merchandise to be verified;

determining via a merchandise supplier verification server whether the user-inputted merchandise identification code is prestored; if yes, then displaying on a user query page a label pattern of an anti-counterfeiting label corresponding to the user-inputted merchandise identification code before being delivered to a merchandise supplier and an anti-counterfeiting pattern prestored and corresponding to the user-inputted identification code, specifically:

determining via the merchandise supplier verification server whether the user-inputted merchandise identification code is prestored and whether the verification password is correct, if the user-inputted merchandise identification code being prestored in the merchandise supplier verification server and the verification password being correct, then displaying on a user query page a label pattern of an anti-counterfeiting label corresponding to the user-inputted merchandise identification code before being delivered to a merchandise supplier and an anti-counterfeiting pattern prestored and corresponding to the user-inputted identification code; and recording via the merchandise supplier verification server the user-inputted identification code being verified, and prompting when being verified again.

At a second aspect, the present invention provides a system for verifying merchandise authenticity, the system comprises a merchandise supplier verification server and a label supplier verification server, wherein,

the merchandise supplier verification receives a user-inputted merchandise identification code in an anti-counterfeiting label attached to a merchandise to be verified, and each anti-counterfeiting label corresponding to one identification code;

the merchandise supplier verification server determines whether the user-inputted merchandise identification code is prestored; if yes, then displays on a user query page a label pattern of an anti-counterfeiting label corresponding to the user-inputted merchandise identification code before being delivered to a merchandise supplier and an anti-counterfeiting pattern prestored and corresponding to the user-inputted identification code, whereby the user can compare the label pattern and the anti-counterfeiting pattern respectively with a label pattern and an anti-counterfeiting pattern of the merchandise to be verified, and thus verify whether the merchandise is authentic; wherein the anti-counterfeiting pattern: is a label pattern of an anti-counterfeiting label after anti-counterfeiting treatment by the merchandise supplier which is delivered by the label supplier, or is constructed by an anti-counterfeiting label attached to a textured carrier together with a texture of the carrier, or is an anti-counterfeiting pattern on merchandise packaging; when the anti-counterfeiting pattern is an anti-counterfeiting pattern on merchandise packaging, the anti-counterfeiting pattern and/or label pattern on merchandise packaging are random.

At a third aspect, the present invention provides a method for verifying merchandise authenticity, the method comprises steps of:

receiving via a label supplier verification server a user-inputted merchandise identification code in an anti-counterfeiting label attached to a merchandise to be verified, and each anti-counterfeiting label corresponding to one identification code;

determining via a label supplier verification server whether the user-inputted merchandise identification code being prestored; if yes, then displaying on a user query page an anti-counterfeiting pattern corresponding to the user-inputted identification code and a label pattern of an anti-counterfeiting label prestored corresponding to the user-inputted merchandise identification code before being delivered to a merchandise supplier, and whereby the user can compare the label pattern and the anti-counterfeiting pattern respectively with a label pattern and an anti-counterfeiting pattern of the merchandise to be verified, and thus verify whether the merchandise is authentic; wherein the anti-counterfeiting pattern: is a label pattern of an anti-counterfeiting label after anti-counterfeiting treatment by the merchandise supplier which is delivered by the label supplier, or is constructed by an anti-counterfeiting label attached to a textured carrier together with a texture of the carrier, or is an anti-counterfeiting pattern on merchandise packaging; when the anti-counterfeiting pattern is an anti-counterfeiting pattern on merchandise packaging, the anti-counterfeiting pattern and/or label pattern on merchandise packaging are random.

Further, if the anti-counterfeiting pattern is a label pattern of an anti-counterfeiting label after anti-counterfeiting treatment by the merchandise supplier which is delivered by the label supplier, or is constructed by an anti-counterfeiting label attached to a textured carrier together with a texture of the carrier, then pre-collecting the anti-counterfeiting pattern corresponding to the user-inputted merchandise identification code by the merchandise supplier and being stored in the merchandise supplier verification server, then storing a link address corresponding to the anti-counterfeiting pattern in the label supplier verification server provided by the merchandise supplier verification server or storing the anti-counterfeiting patterns in the label supplier verification server provided by the merchandise supplier verification server;

further, if the anti-counterfeiting pattern being an anti-counterfeiting pattern on merchandise packaging, pre-collecting the anti-counterfeiting patterns corresponding to the user-inputted merchandise identification code by the merchandise supplier or a packaging supplier and storing them in the merchandise supplier verification server; storing link address corresponding to the anti-counterfeiting patterns provided by the merchandise supplier verification server in the label supplier verification server, or storing the anti-counterfeiting patterns provided by the merchandise supplier verification server in the label supplier verification server, or if determining the user-inputted merchandise identification code being prestored in the label supplier verification server, sending query instructions from the label supplier verification server to the merchandise supplier verification server, and then sending the prestored anti-counterfeiting pattern of an anti-counterfeiting label corresponding to the user-inputted merchandise identification code by the merchandise supplier verification server to the label supplier verification server;

pre-collecting by the label supplier the label patterns of anti-counterfeiting labels corresponding to the user-inputted merchandise identification codes before being delivered to a merchandise supplier, and storing them in the label supplier verification server.

Further, the anti-counterfeiting label is printed with a verification password area for a verification password to be inputted when verifying authenticity of a merchandise with the anti-counterfeiting label through a server, a surface of the verification password area has a covering layer; the method further comprises a step of: receiving via the label supplier verification server the user-inputted verification password in the anti-counterfeiting label attached to the merchandise to be verified;

determining via the label supplier verification server whether the user-inputted merchandise identification code being prestored; if yes, then displaying on a user query page an anti-counterfeiting pattern corresponding to the user-inputted merchandise identification code and a prestored label pattern of an anti-counterfeiting label corresponding to the user-inputted merchandise identification code before being delivered to a merchandise supplier, specifically:

determining via the label supplier verification server whether the user-inputted merchandise identification code being prestored and whether the verification password being correct, if the user-inputted merchandise identification code being prestored in the label supplier verification server and the verification password being correct, then displaying on a user query page an anti-counterfeiting pattern corresponding to the user-inputted identification code and a prestored label pattern of an anti-counterfeiting label corresponding to the user-inputted merchandise identification code before being delivered to a merchandise supplier and; and recording via the label supplier verification server the user-inputted identification code being verified, and prompting when being verified again.

At a fourth aspect, the present invention provides a system for verifying merchandise authenticity, the system comprises a label supplier verification server and a merchandise supplier verification server, herein,

the label supplier verification server receives a user-inputted merchandise identification code in an anti-counterfeiting label attached to a merchandise to be verified, and each anti-counterfeiting label corresponding to one identification code;

the label supplier verification server is used for determining whether the user-inputted merchandise identification code being prestored; if yes, then displays on a user query page an anti-counterfeiting pattern corresponding to the user-inputted identification code and a label pattern of an anti-counterfeiting label prestored corresponding to the user-inputted merchandise identification code before being delivered to a merchandise supplier, and whereby the user can compare the label pattern and the anti-counterfeiting pattern respectively with a label pattern and an anti-counterfeiting pattern of the merchandise to be verified, and thus verify whether the merchandise is authentic; wherein the anti-counterfeiting pattern: is a label pattern of an anti-counterfeiting label after anti-counterfeiting treatment by the merchandise supplier which is delivered by the label supplier, or is constructed by an anti-counterfeiting label attached to a textured carrier together with a texture of the carrier, or is an anti-counterfeiting pattern on merchandise packaging; when the anti-counterfeiting pattern is an anti-counterfeiting pattern on merchandise packaging, the anti-counterfeiting pattern and/or label pattern on merchandise packaging are random.

### ADVANTAGES OF THE PRESENT INVENTION

### Advantages

In this present invention, by logging the merchandise supplier verification server and the label supplier verification server, displaying on a user query page an anti-counterfeiting pattern corresponding to the user-inputted identification code and a label pattern of an anti-counterfeiting label corresponding to the user-inputted merchandise identification code before being delivered to a merchandise supplier at the same time, the user can verify merchandise authenticity by comparing them. That is, the verifying information obtained by the consumer comes from both the label supplier and the merchandise supplier, and the texture information seen from the anti-counterfeiting pattern and the label pattern can be corroborated by each other, therefore, it is very highly reliable. If the label pattern of the same item does not correspond to the anti-counterfeiting pattern, the possibility exists as follows: a. labels produced by label supplier are not all delivered to the merchandise supplier; b. illegal label data is maliciously added to the label supplier verification server; c. the merchandise supplier has lost anti-counterfeiting labels, which are attached to the fake by the counterfeiters; d. illegal label data is maliciously added to the merchandise supplier verification server. Therefore, the present invention allows the determination of the authenticity of a merchandise.

### BRIEF DESCRIPTION OF THE DRAWINGS

FIG. 1 is a flow chart illustrating a method for verifying merchandise authenticity in accordance with a first embodiment of the present invention; and

FIG. 2 is a flow chart illustrating a method for verifying merchandise authenticity in accordance with a third embodiment of the present invention.

### DETAILED DESCRIPTION

Aspects, features, and advantages of the present invention will become clearer and better understood by reference to the following detailed description of the embodiments of the invention when considered in connection with the accompanying drawings. The following description of certain embodiments of the invention are not intended to limit the invention to these embodiments, but rather, are only explains the present invention.

The features of the present are now described in connection with the following detailed embodiments.

### First Embodiment

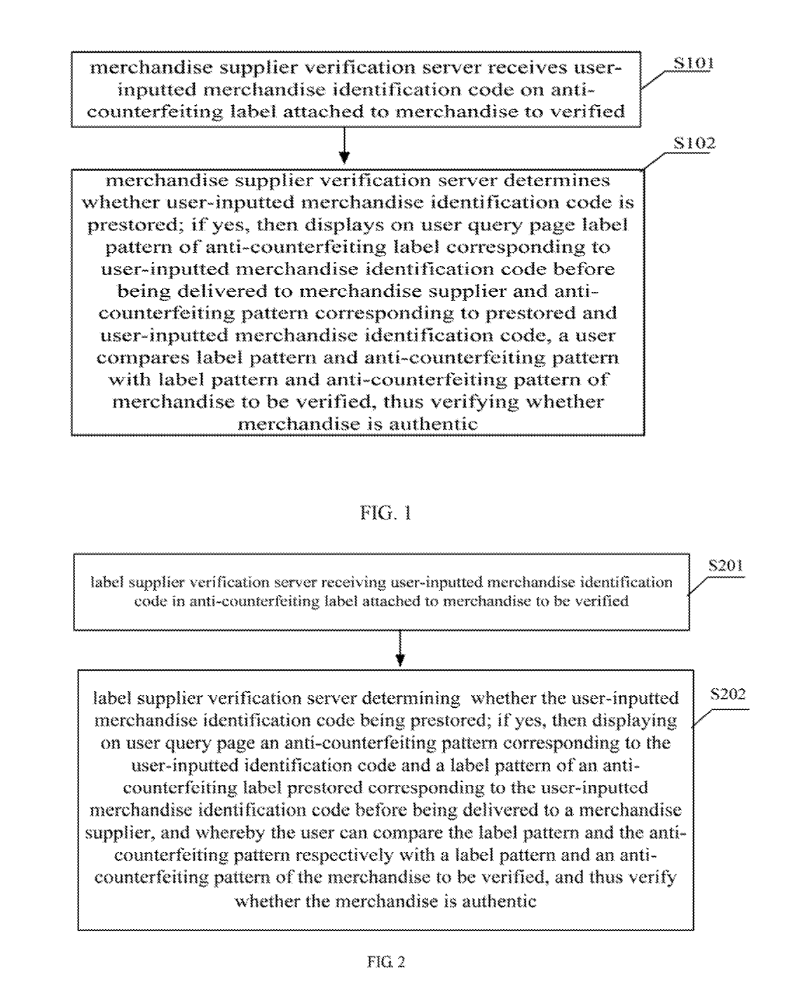

Referring to FIG. 1, a method for verifying merchandise authenticity in the first embodiment of the present invention comprises a step of logging in to a merchandise supplier verification server for verification, specifically comprises the following steps of:

S101, the merchandise supplier verification server receives a user-inputted merchandise identification code on an anti-counterfeiting label attached to the merchandise to verified.

In accordance with the first embodiment of the present invention, a user may input the identification code in the anti-counterfeiting label attached to the item to be verified via logging in to the corresponding web page, APP, WeChat application and other ways of the label supplier verification server through a computer anti-counterfeiting label attached to the item to be verified.

S102, the merchandise supplier verification server determines whether the user-inputted merchandise identification code is prestored; if yes, then displays on user query page a label pattern of an anti-counterfeiting label corresponding to user-inputted merchandise identification code before being delivered to the merchandise supplier and an anti-counterfeiting pattern corresponding to prestored and the user-inputted merchandise identification code, the user compares the label pattern and the anti-counterfeiting pattern with a label pattern and an anti-counterfeiting pattern of the merchandise to be verified, thus verifying whether merchandise is authentic.

In the first embodiment of the present invention, if the anti-counterfeiting pattern is a label pattern of an anti-counterfeiting label after anti-counterfeiting treatment by the merchandise supplier which is delivered by the label supplier, or is constructed by an anti-counterfeiting label attached to a textured carrier together with a texture of the carrier, the anti-counterfeiting pattern corresponding to the user-inputted merchandise identification code is collected by the merchandise supplier, and is stored in the merchandise supplier verification server;

if the anti-counterfeiting pattern is an anti-counterfeiting pattern on merchandise packaging, the anti-counterfeiting pattern corresponding to the user-inputted merchandise identification code is collected by the merchandise supplier or a packaging supplier, and is stored in the merchandise supplier verification server;

the label pattern of an anti-counterfeiting label corresponding to the user-inputted merchandise identification code before being delivered to a merchandise supplier is pre-collected by the label supplier, and is stored in a label supplier verification server; the merchandise supplier verification server stores a link address corresponding to the label pattern provided by the label supplier verification server, or the merchandise supplier verification server stores the label pattern provided by the label supplier verification server, or if the merchandise supplier verification server determines that the merchandise identification code inputted by the user is prestored, the merchandise supplier verification server sends query instructions to the label supplier verification server, and then the label supplier verification server send the merchandise supplier verification server the prestored label pattern of an anti-counterfeiting label corresponding to the user-inputted merchandise identification code before being delivered to a merchandise supplier.

In accordance with the first embodiment of the present invention, the anti-counterfeiting pattern on merchandise packaging can be one or any combination of text, numbers, symbols, graphics. If the anti-counterfeiting pattern is an anti-counterfeiting pattern on the merchandise packaging, the anti-counterfeiting pattern and/or label pattern on the merchandise packaging is random. Therefore, the anti-counterfeiting label can completely cover, partially cover or not cover the anti-counterfeiting pattern on the merchandise packaging.

If the carrier has no texture, then the anti-counterfeiting pattern is the label pattern after the merchandise supplier performs an anti-counterfeiting process to the anti-counterfeiting label delivered by the marketer. For example, the merchandise supplier receives an anti-counterfeiting label delivered by the label supplier and then randomly cuts the edge of the anti-counterfeiting label to form a random outline, or prints a random color near the edge of the anti-counterfeiting label.

In accordance with the first embodiment of the present invention, the carrier may be the merchandise itself or the outer packaging of the merchandise. The anti-counterfeiting label is printed with a verification password area for a verification password to be inputted when verifying authenticity of a merchandise with the anti-counterfeiting label through a server, a surface of the verification password area has a covering layer.

In accordance with the first embodiment of the present invention, the label supplier verification server also stores label user's information corresponding to the label pattern, such as the name of the merchandise supplier, the list of merchandise, the time of receiving the label, etc. The label user's can also be sent to the user query page. The merchandise supplier verification server also keeps the merchandise information corresponding to the anti-counterfeiting pattern, such as product name, place of origin, batch, specification, production date, sales area, inspection record, etc., and the merchandise information can also be sent to the user inquiry page.

In accordance with the first embodiment of the present invention, if there is a verification password in the anti-counterfeiting label, S101 further comprises a step of: receiving via the merchandise supplier verification server the user-inputted verification password in the anti-counterfeiting label attached to the merchandise to be verified.

Determining via a merchandise supplier verification server whether the user-inputted merchandise identification code being prestored; if yes, then displaying on a user query page an anti-counterfeiting label corresponding to the user-inputted merchandise identification code and an anti-counterfeiting pattern prestored and corresponding to the user-inputted identification code before being delivered to a merchandise supplier, specifically:

determining via the merchandise supplier verification server whether the user-inputted merchandise identification code is prestored and whether the verification password is correct, if the user-inputted merchandise identification code being prestored in the merchandise supplier verification server and the verification password being correct, then displaying on a user query page a label pattern of an anti-counterfeiting label corresponding to the user-inputted merchandise identification code before being delivered to a merchandise supplier and an anti-counterfeiting pattern prestored and corresponding to the user-inputted identification code; and recording via the merchandise supplier verification server the user-inputted identification code being verified, and prompting when being verified again.

In accordance with the first embodiment of the present invention, a detail content for recording the user-inputted identification code been verified include: when, where, how, and who has verified it, in such way to prevented a tracing and tracking, reusing an old packaging. Big data analysis can also be used to analyze the sales differences of the goods in different regions, in order to learn the consumption habits of different regions, and for the merchandise supplier to adjust of business strategies.

Because the merchandise supplier verification server has recorded the user-inputted identification code been verified, when the anti-counterfeiting label is repaired by the illegal persons and attached to the fake, when the user who has bought the fake commodity and verify the authenticity of the merchandise, The merchandise supplier verification server will prompt the user that the user-inputted identification code has been verified, so that the user can know that the goods purchased are fake.

### Second Embodiment

In accordance with the second embodiment of the present invention, a system for verifying merchandise authenticity comprises a merchandise supplier verification server and a label supplier verification server, herein

the merchandise supplier verification server receives a user-inputted merchandise identification code in an anti-counterfeiting label attached to a merchandise to be verified, and each anti-counterfeiting label corresponding to one identification code;

the merchandise supplier verification server is used for determining whether the user-inputted merchandise identification code is prestored; if yes, then displaying on a user query page a label pattern of an anti-counterfeiting label corresponding to the user-inputted merchandise identification code before being delivered to a merchandise supplier and an anti-counterfeiting pattern prestored and corresponding to the user-inputted identification code, whereby the user can compare the label pattern and the anti-counterfeiting pattern respectively with a label pattern and an anti-counterfeiting pattern of the merchandise to be verified, and thus verify whether the merchandise is authentic; wherein the anti-counterfeiting pattern: is a label pattern of an anti-counterfeiting label after anti-counterfeiting treatment by the merchandise supplier which is delivered by the label supplier, or is constructed by an anti-counterfeiting label attached to a textured carrier together with a texture of the carrier, or is an anti-counterfeiting pattern on merchandise packaging; when the anti-counterfeiting pattern is an anti-counterfeiting pattern on merchandise packaging, the anti-counterfeiting pattern and/or label pattern on merchandise packaging are random.

If the carrier has no texture, then the anti-counterfeiting pattern is the label pattern after the merchandise supplier performs an anti-counterfeiting process to the anti-counterfeiting label delivered by the marketer. For example, the merchandise supplier receives an anti-counterfeiting label delivered by the label supplier and then randomly cuts the edge of the anti-counterfeiting label to form a random outline, or prints a random color near the edge of the anti-counterfeiting label.

In accordance with the second embodiment of the present invention, the carrier may be the merchandise itself or the outer packaging of the merchandise. The anti-counterfeiting label is printed with a verification password area for a verification password to be inputted when verifying authenticity of a merchandise with the anti-counterfeiting label through a server, a surface of the verification password area has a covering layer.

In accordance with the second embodiment of the present invention, the label supplier verification server also stores label user's information corresponding to the label pattern, such as the name of the merchandise supplier, the list of merchandise, the time of receiving the label, etc. The label user's can also be sent to the user query page. The merchandise supplier verification server also keeps the merchandise information corresponding to the anti-counterfeiting pattern, such as product name, place of origin, batch, specification, production date, sales area, inspection record, etc., and the merchandise information can also be sent to the user inquiry page.

In accordance with the second embodiment of the present invention, if there is a verification password in the anti-counterfeiting label, the merchandise supplier verification server is further used for receiving the user-inputted verification password in the anti-counterfeiting label attached to the merchandise to be verified.

Determining via a merchandise supplier verification server whether the user-inputted merchandise identification code is prestored; if yes, then displaying on a user query page a label pattern of an anti-counterfeiting label corresponding to the user-inputted merchandise identification code before being delivered to a merchandise supplier and an anti-counterfeiting pattern prestored and corresponding to the user-inputted identification code, specifically:

determining via the merchandise supplier verification server whether the user-inputted merchandise identification code is prestored and whether the verification password is correct, if the user-inputted merchandise identification code being prestored in the merchandise supplier verification server and the verification password being correct, then displaying on a user query page a label pattern of an anti-counterfeiting label corresponding to the user-inputted merchandise identification code before being delivered to a merchandise supplier and an anti-counterfeiting pattern prestored and corresponding to the user-inputted identification code; and recording via the merchandise supplier verification server the user-inputted identification code being verified, and prompting when being verified again.

In accordance with the second embodiment of the present invention, a detail content for recording the user-inputted identification code been verified include: when, where, how, and who has verified it, in such way to prevented a tracing and tracking, reusing an old packaging. Big data analysis can also be used to analyze the sales differences of the goods in different regions, in order to learn the consumption habits of different regions, and for the merchandise supplier to adjust of business strategies.

### Third Embodiment

Referring to FIG. 2, a method for verifying merchandise authenticity in the third embodiment of the present invention comprises a step of logging in to a label supplier verification server for verification, specifically comprises the following steps of:

S201, receiving via a label supplier verification server a user-inputted merchandise identification code in an anti-counterfeiting label attached to a merchandise to be verified, and each anti-counterfeiting label corresponding to one identification code;

In accordance with the third embodiment of the present invention, a user may input the identification code in the anti-counterfeiting label attached to the item to be verified via logging in to the corresponding web page, APP, WeChat application and other ways of the label supplier verification server through a computer, a mobile phone or other mobile communication device.

S202, determining via a label supplier verification server whether the user-inputted merchandise identification code being prestored; if yes, then displaying on a user query page an anti-counterfeiting pattern corresponding to the user-inputted identification code and a label pattern of an anti-counterfeiting label prestored corresponding to the user-inputted merchandise identification code before being delivered to a merchandise supplier, and whereby the user can compare the label pattern and the anti-counterfeiting pattern respectively with a label pattern and an anti-counterfeiting pattern of the merchandise to be verified, and thus verify whether the merchandise is authentic; wherein the anti-counterfeiting pattern: is a label pattern of an anti-counterfeiting label after anti-counterfeiting treatment by the merchandise supplier which is delivered by the label supplier, or is constructed by an anti-counterfeiting label attached to a textured carrier together with a texture of the carrier, or is an anti-counterfeiting pattern on merchandise packaging; when the anti-counterfeiting pattern is an anti-counterfeiting pattern on merchandise packaging, the anti-counterfeiting pattern and/or label pattern on merchandise packaging are random.

In accordance with the third embodiment of the present invention, if the anti-counterfeiting pattern is a label pattern of an anti-counterfeiting label after anti-counterfeiting treatment by the merchandise supplier which is delivered by the label supplier, or is constructed by an anti-counterfeiting label attached to a textured carrier together with a texture of the carrier, then pre-collecting the anti-counterfeiting pattern corresponding to the user-inputted merchandise identification code by the merchandise supplier and being stored in the merchandise supplier verification server, then storing a link address corresponding to the anti-counterfeiting pattern in the label supplier verification server provided by the merchandise supplier verification server or storing the anti-counterfeiting patterns in the label supplier verification server provided by the merchandise supplier verification server; or if determining the user-inputted merchandise identification code being prestored via the label supplier verification server, sending query instructions via the label supplier verification server to the merchandise supplier verification server, and then sending the prestored anti-counterfeiting pattern corresponding to the user-inputted merchandise identification code via the merchandise supplier verification server to the label supplier verification server;

if the anti-counterfeiting pattern being an anti-counterfeiting pattern on merchandise packaging, pre-collecting the anti-counterfeiting patterns corresponding to the user-inputted merchandise identification code by the merchandise supplier or a packaging supplier and storing them in the merchandise supplier verification server; storing link address corresponding to the anti-counterfeiting patterns provided by the merchandise supplier verification server in the label supplier verification server, or storing the anti-counterfeiting patterns provided by the merchandise supplier verification server in the label supplier verification server;

pre-collecting by the label supplier the label pattern of an anti-counterfeiting label corresponding to the user-inputted merchandise identification code before being delivered to a merchandise supplier, and being stored in the label supplier verification server.

In accordance with the third embodiment of the present invention, the anti-counterfeiting pattern on merchandise packaging can be one or any combination of text, numbers, symbols, graphics. If the anti-counterfeiting pattern is an anti-counterfeiting pattern on the merchandise packaging, the anti-counterfeiting pattern and/or label pattern on the merchandise packaging is random. Therefore, the anti-counterfeiting label can completely cover, partially cover or not cover the anti-counterfeiting pattern on the merchandise packaging.

If the carrier has no texture, then the anti-counterfeiting pattern is the label pattern after the merchandise supplier performs an anti-counterfeiting process to the anti-counterfeiting label delivered by the marketer. For example, the merchandise supplier receives an anti-counterfeiting label delivered by the label supplier and then randomly cuts the edge of the anti-counterfeiting label to form a random outline, or prints a random color near the edge of the anti-counterfeiting label.

In accordance with the third embodiment of the present invention, the carrier may be the merchandise itself or the outer packaging of the merchandise. The anti-counterfeiting label is printed with a verification password area for a verification password to be inputted when verifying authenticity of a merchandise with the anti-counterfeiting label through a server, a surface of the verification password area has a covering layer.

In accordance with the third embodiment of the present invention, the label supplier verification server also stores label user's information corresponding to the label pattern, such as the name of the merchandise supplier, the list of merchandise, the time of receiving the label, etc. The label user's can also be sent to the user query page. The merchandise supplier verification server also keeps the merchandise information corresponding to the anti-counterfeiting pattern, such as product name, place of origin, batch, specification, production date, sales area, inspection record, etc., and the merchandise information can also be sent to the user inquiry page.

In accordance with the third embodiment of the present invention, if there is a verification password in the anti-counterfeiting label, S201 further comprises a step of: receiving via the label supplier verification server the user-inputted verification password in the anti-counterfeiting label attached to the merchandise to be verified.

Determining via a label supplier verification server whether the user-inputted merchandise identification code being prestored; if yes, then displaying on a user query page an anti-counterfeiting pattern corresponding to the user-inputted merchandise identification code and a prestored label pattern of an anti-counterfeiting label corresponding to the user-inputted merchandise identification code before being delivered to a merchandise supplier, specifically:

determining via the label supplier verification server whether the user-inputted merchandise identification code being prestored and whether the verification password being correct, if the user-inputted merchandise identification code being prestored in the label supplier verification server and the verification password being correct, then displaying on a user query page an anti-counterfeiting pattern corresponding to the user-inputted identification code and a prestored label pattern of an anti-counterfeiting label corresponding to the user-inputted merchandise identification code before being delivered to a merchandise supplier and; and recording via the label supplier verification server the user-inputted identification code being verified, and prompting when verifying again.

In accordance with the third embodiment of the present invention, a detail content for recording the user-inputted identification code been verified include: when, where, how, and who has verified it, in such way to prevented a tracing and tracking, reusing an old packaging. Big data analysis can also be used to analyze the sales differences of the goods in different regions, in order to learn the consumption habits of different regions, and for the merchandise supplier to adjust of business strategies.

### Fourth Embodiment

In accordance with the fourth embodiment of the present invention, a system for verifying merchandise authenticity comprises a label supplier verification server and a merchandise supplier verification server, herein

a label supplier verification server receives a user-inputted merchandise identification code in an anti-counterfeiting label attached to a merchandise to be verified, and each anti-counterfeiting label corresponding to one identification code;

the label supplier verification server is used for determining whether the user-inputted merchandise identification code being prestored; if yes, then displaying on a user query page an anti-counterfeiting pattern corresponding to the user-inputted identification code and a label pattern of an anti-counterfeiting label prestored corresponding to the user-inputted merchandise identification code before being delivered to a merchandise supplier, and whereby the user can compare the label pattern and the anti-counterfeiting pattern respectively with a label pattern and an anti-counterfeiting pattern of the merchandise to be verified, and thus verify whether the merchandise is authentic; wherein the anti-counterfeiting pattern: is a label pattern of an anti-counterfeiting label after anti-counterfeiting treatment by the merchandise supplier which is delivered by the label supplier, or is constructed by an anti-counterfeiting label attached to a textured carrier together with a texture of the carrier, or is an anti-counterfeiting pattern on merchandise packaging; when the anti-counterfeiting pattern is an anti-counterfeiting pattern on merchandise packaging, the anti-counterfeiting pattern and/or label pattern on merchandise packaging are random.

If the carrier has no texture, then the anti-counterfeiting pattern is the label pattern after the merchandise supplier performs an anti-counterfeiting process to the anti-counterfeiting label delivered by the marketer. For example, the merchandise supplier receives an anti-counterfeiting label delivered by the label supplier and then randomly cuts the edge of the anti-counterfeiting label to form a random outline, or prints a random color near the edge of the anti-counterfeiting label.

In accordance with the four embodiment of the present invention, the carrier may be the merchandise itself or the outer packaging of the merchandise. The anti-counterfeiting label is printed with a verification password area for a verification password to be inputted when verifying authenticity of a merchandise with the anti-counterfeiting label through a server, a surface of the verification password area has a covering layer.

In accordance with the four embodiment of the present invention, the label supplier verification server also stores label user's information corresponding to the label pattern, such as the name of the merchandise supplier, the list of merchandise, the time of receiving the label, etc. The label user's can also be sent to the user query page. The merchandise supplier verification server also keeps the merchandise information corresponding to the anti-counterfeiting pattern, such as product name, place of origin, batch, specification, production date, sales area, inspection record, etc., and the merchandise information can also be sent to the user inquiry page.

In accordance with the four embodiment of the present invention, if there is a verification password in the anti-counterfeiting label, the label supplier verification server is further used for receiving the user-inputted verification password in the anti-counterfeiting label attached to the merchandise to be verified.

determining via a label supplier verification server whether the user-inputted merchandise identification code being prestored; if yes, then displaying on a user query page an anti-counterfeiting pattern corresponding to the user-inputted merchandise identification code and a prestored label pattern of an anti-counterfeiting label corresponding to the user-inputted merchandise identification code before being delivered to a merchandise supplier, specifically:

determining via the label supplier verification server whether the user-inputted merchandise identification code being prestored and whether the verification password being correct, if the user-inputted merchandise identification code being prestored in the label supplier verification server and the verification password being correct, then displaying on a user query page an anti-counterfeiting pattern corresponding to the user-inputted identification code and a prestored label pattern of an anti-counterfeiting label corresponding to the user-inputted merchandise identification code before being delivered to a merchandise supplier and; and recording via the label supplier verification server the user-inputted identification code being verified, and prompting when verifying again.

In accordance with the four embodiment of the present invention, a detail content for recording the user-inputted identification code been verified include: when, where, how, and who has verified it, in such way to prevented a tracing and tracking, reusing an old packaging. Big data analysis can also be used to analyze the sales differences of the goods in different regions, in order to learn the consumption habits of different regions, and for the merchandise supplier to adjust of business strategies.

In this present invention, by logging the merchandise supplier verification server and the label supplier verification server, displaying on a user query page an anti-counterfeiting pattern corresponding to the user-inputted identification code and a label pattern of an anti-counterfeiting label corresponding to the user-inputted merchandise identification code before being delivered to a merchandise supplier at the same time, the user can verify merchandise authenticity by comparing them. That is, the verifying information obtained by the consumer comes from both the label supplier and the merchandise supplier, and the texture information seen from the anti-counterfeiting pattern and the label pattern can be corroborated by each other, therefore, it is very highly reliable. If the label pattern of the same item does not correspond to the anti-counterfeiting pattern, the possibility exists as follows: a. labels produced by label supplier are not all delivered to the merchandise supplier; b. illegal label data is maliciously added to the label supplier verification server; c. the merchandise supplier has lost anti-counterfeiting labels, which are attached to the fake by the counterfeiters; d. illegal label data is maliciously added to the merchandise supplier verification server. Therefore, the present invention allows the determination of the authenticity of a merchandise.

Those skilled in the art can understand that all or part of the steps of the method described in the above-mentioned embodiments can be performed by program to instruct the related hardware, the program can be stored in a computer readable storage medium, and the storage medium includes such as a ROM/RAM, disk, an optical disc, and the like.

The above mentioned is preferable embodiments of the invention and is not intended to limit the scope of the inventions. Any modification, substitution and improvements, etc., may be made without departing from the spirit of the inventions, shall be included in the protection scope of the invention.

The above mentioned is preferable embodiments of the invention and is not intended to limit the scope of the inventions. Any modification, substitution and improvements, etc., may be made without departing from the spirit of the inventions, shall be included in the protection scope of the invention.

What is claimed is:

1. A method for verifying merchandise authenticity, comprising steps of:
receiving a user-inputted identification code in an anti-counterfeiting label attached to a merchandise to be verified, and each anti-counterfeiting label corresponding to one identification code; and
determining via a merchandise supplier verification server whether the user-inputted identification code is prestored; if yes, then displaying on a user query page a label pattern of an anti-counterfeiting label corresponding to the user-inputted identification code before being delivered to a merchandise supplier and an anti-counterfeiting pattern prestored and corresponding to the user-inputted identification code, whereby comparing the label pattern and the anti-counterfeiting pattern respectively with a label pattern and an anti-counterfeiting pattern of the merchandise to be verified by the user, and thus verifying whether the merchandise being authentic; wherein the anti-counterfeiting pattern: is a label pattern of an anti-counterfeiting label after anti-counterfeiting treatment by the merchandise supplier which is delivered by the label supplier, or is constructed by an anti-counterfeiting label attached to a textured carrier together with a texture of the carrier, or is an anti-counterfeiting pattern on merchandise packaging; when the anti-counterfeiting pattern is an anti-counterfeiting pattern on merchandise packaging, the anti-counterfeiting pattern and/or label pattern on merchandise packaging are random.

2. The method of claim 1, wherein:
if the anti-counterfeiting pattern is a label pattern of an anti-counterfeiting label after anti-counterfeiting treatment by the merchandise supplier which is delivered by the label supplier, or is constructed by an anti-counterfeiting label attached to a textured carrier together with a texture of the carrier, collecting the anti-counterfeiting pattern corresponding to the user-inputted identification code by the merchandise supplier, and storing it in the merchandise supplier verification server;
if the anti-counterfeiting pattern is an anti-counterfeiting pattern on merchandise packaging, collecting the anti-counterfeiting pattern corresponding to the user-inputted identification code by the merchandise supplier or a packaging supplier, and storing it in the merchandise supplier verification server;
pre-collecting by the label supplier the label pattern of an anti-counterfeiting label corresponding to the user-inputted identification code before being delivered to a merchandise supplier, and storing it in a label supplier verification server; storing a link address corresponding to the label pattern provided by the label supplier verification server in the merchandise supplier verification server, or storing the label pattern provided by the label supplier verification server in the merchandise supplier verification server, or if the merchandise supplier verification server determines that the identification code inputted by the user is prestored, sending query instructions via the merchandise supplier verification server to the label supplier verification server, and then sending a prestored label pattern of an anti-counterfeiting label corresponding to the user-inputted identification code before being delivered to a merchandise supplier to the merchandise supplier verification server via the label supplier verification server.

3. The method of claim 1 or 2, wherein, the anti-counterfeiting label is printed with a verification password area for a verification password to be inputted when verifying authenticity of a merchandise with the anti-counterfeiting label through a server, a surface of the verification password area has a covering layer;
the method further comprises a step of: receiving via the merchandise supplier verification server the user-inputted verification password in the anti-counterfeiting label attached to the merchandise to be verified;
determining via the merchandise supplier verification server whether the user-inputted identification code is prestored; if yes, then displaying on a user query page a label pattern of an anti-counterfeiting label corresponding to the user-inputted identification code before being delivered to a merchandise supplier and an anti-counterfeiting pattern prestored and corresponding to the user-inputted identification code, specifically:
determining via the merchandise supplier verification server whether the user-inputted identification code is prestored and whether the verification password is correct, if the user-inputted identification code being prestored in the merchandise supplier verification server and the verification password being correct, then displaying on a user query page a label pattern of an anti-counterfeiting label corresponding to the user-inputted identification code before being delivered to a merchandise supplier and an anti-counterfeiting pattern prestored and corresponding to the user-inputted identification code; and recording via the merchandise supplier verification server the user-inputted identification code being verified, and prompting when verifying again.

4. A system for verifying merchandise authenticity, comprising a merchandise supplier verification server and a label supplier verification server, wherein:
the merchandise supplier verification server is used for receiving a user-inputted identification code in an anti-counterfeiting label attached to a merchandise to be verified, and each anti-counterfeiting label corresponding to one identification code;
the merchandise supplier verification server determines whether the user-inputted identification code is prestored; if yes, then displays on a user query page a label pattern of an anti-counterfeiting label corresponding to the user-inputted identification code before being delivered to a merchandise supplier and an anti-counterfeiting pattern prestored and corresponding to the user-inputted identification code, whereby the user can compare the label pattern and the anti-counterfeiting pattern respectively with a label pattern and an anti-counterfeiting pattern of the merchandise to be verified, and thus verify whether the merchandise is authentic; wherein the anti-counterfeiting pattern: is a label pattern of an anti-counterfeiting label after anti-counterfeiting treatment by the merchandise supplier which is delivered by the label supplier, or is constructed by an anti-counterfeiting label attached to a textured carrier together with a texture of the carrier, or is an anti-counterfeiting pattern on merchandise packaging; when the anti-counterfeiting pattern is an anti-counterfeiting pattern on merchandise packaging, the anti-counterfeiting pattern and/or label pattern on merchandise packaging are random;
the label supplier verification server is used for storing the label pattern of an anti-counterfeiting label corresponding to the user-inputted identification code before being delivered to a merchandise supplier.

5. The system of claim 4, wherein the anti-counterfeiting label is printed with a verification password area for a verification password to be inputted when verifying authenticity of a merchandise with the anti-counterfeiting label through a server, a surface of the verification password area has a covering layer;
the merchandise supplier verification server is further used for receiving the user-inputted verification password in the anti-counterfeiting label attached to the merchandise to be verified;
the merchandise supplier verification server determines whether the user-inputted identification code is prestored; if yes, then displays on a user query page a label pattern of an anti-counterfeiting label corresponding to the user-inputted identification code before being delivered to a merchandise supplier and an anti-counterfeiting pattern prestored and corresponding to the user-inputted identification code, specifically:
the merchandise supplier verification server determines whether the user-inputted identification code is prestored and whether the verification password is correct, if the user-inputted identification code being prestored in the merchandise supplier verification server and the verification password being correct, then displays on a user query page a label pattern of an anti-counterfeiting label corresponding to the user-inputted identification code before being delivered to a merchandise supplier and an anti-counterfeiting pattern prestored and corresponding to the user-inputted identification code; and the merchandise supplier verification server records that the user-inputted identification code has been verified, and prompt when being verified again.

6. A method for verifying merchandise authenticity, comprising steps of:
receiving via a label supplier verification server a user-inputted identification code in an anti-counterfeiting label attached to a merchandise to be verified, and each anti-counterfeiting label corresponding to one identification code;
determining via a label supplier verification server whether the user-inputted identification code being prestored; if yes, then displaying on a user query page an anti-counterfeiting pattern corresponding to the user-inputted identification code and a label pattern of an anti-counterfeiting label prestored corresponding to the user-inputted identification code before being delivered to a merchandise supplier, and whereby the user can compare the label pattern and the anti-counterfeiting pattern respectively with a label pattern and an anti-counterfeiting pattern of the merchandise to be verified, and thus verify whether the merchandise is authentic; wherein the anti-counterfeiting pattern: is a label pattern of an anti-counterfeiting label after anti-counterfeiting treatment by the merchandise supplier which is delivered by the label supplier, or is constructed by an anti-counterfeiting label attached to a textured carrier together with a texture of the carrier, or is an anti-counterfeiting pattern on merchandise packaging; when the anti-counterfeiting pattern is an anti-counterfeiting pattern on merchandise packaging, the anti-counterfeiting pattern and/or label pattern on merchandise packaging are random.

7. The method of claim 6, wherein, if the anti-counterfeiting pattern is a label pattern of an anti-counterfeiting label after anti-counterfeiting treatment by the merchandise supplier which is delivered by the label supplier, or is constructed by an anti-counterfeiting label attached to a textured carrier together with a texture of the carrier, then pre-collecting the anti-counterfeiting pattern corresponding to the user-inputted identification code by the merchandise supplier and being stored in the merchandise supplier verification server, then storing a link address corresponding to the anti-counterfeiting pattern provided by the merchandise supplier verification server in the label supplier verification server, or storing the anti-counterfeiting patterns provided by the merchandise supplier verification server in the label supplier verification server;
further, if the anti-counterfeiting pattern being an anti-counterfeiting pattern on merchandise packaging, pre-collecting the anti-counterfeiting pattern corresponding to the user-inputted identification code by the merchandise supplier or a packaging supplier and storing it in the merchandise supplier verification server;
storing link address corresponding to the anti-counterfeiting patterns provided by the merchandise supplier verification server in the label supplier verification server, or storing the anti-counterfeiting patterns provided by the merchandise supplier verification server in the label supplier verification server, or if the label supplier verification server determining the user-inputted identification code being prestored, sending query instructions via the label supplier verification server to the merchandise supplier verification server, and then sending the prestored anti-counterfeiting pattern of an anti-counterfeiting label corresponding to the user-inputted identification code via the merchandise supplier verification server to the label supplier verification server; and
pre-collecting by the label supplier the label pattern of an anti-counterfeiting label corresponding to the user-inputted identification code before being delivered to a merchandise supplier, and storing it in the label supplier verification server.

8. The method of claim 6 or 7, wherein, the anti-counterfeiting label is printed with a verification password area for a verification password to be inputted when verifying authenticity of a merchandise with the anti-counterfeiting label through a server, a surface of the verification password area has a covering layer;
the method further comprises a step of: receiving via the label supplier verification server the user-inputted verification password in the anti-counterfeiting label attached to the merchandise to be verified;
determining via a label supplier verification server whether the user-inputted identification code being prestored; if yes, then displaying on a user query page an anti-counterfeiting pattern corresponding to the user-inputted identification code and a prestored label pattern of an anti-counterfeiting label corresponding to the user-inputted identification code before being delivered to a merchandise supplier, specifically:
determining via the label supplier verification server whether the user-inputted identification code being prestored and whether the verification password being correct, if the user-inputted identification code being prestored in the label supplier verification server and the verification password being correct, then displaying on a user query page an anti-counterfeiting pattern corresponding to the user-inputted identification code and a prestored label pattern of an anti-counterfeiting label corresponding to the user-inputted identification code before being delivered to a merchandise supplier and; and recording via the label supplier verification server the user-inputted identification code being verified, and prompting when verifying again.

9. A system for verifying merchandise authenticity, comprising a label supplier verification server and a merchandise supplier verification server, wherein:
the label supplier verification server is used for receiving a user-inputted identification code in an anti-counterfeiting label attached to a merchandise to be verified, and each anti-counterfeiting label corresponding to one identification code;
the label supplier verification server is used for determining whether the user-inputted identification code being prestored; if yes, then displaying on a user query page an anti-counterfeiting pattern corresponding to the user-inputted identification code and a label pattern of an anti-counterfeiting label prestored corresponding to the user-inputted identification code before being delivered to a merchandise supplier, and whereby the user can compare the label pattern and the anti-counterfeiting pattern respectively with a label pattern and an anti-counterfeiting pattern of the merchandise to be verified, and thus verify whether the merchandise is authentic; wherein the anti-counterfeiting pattern: is a label pattern of an anti-counterfeiting label after anti-counterfeiting treatment by the merchandise supplier which is delivered by the label supplier, or is constructed by an anti-counterfeiting label attached to a textured carrier together with a texture of the carrier, or is an anti-counterfeiting pattern on merchandise packaging; when the anti-counterfeiting pattern is an anti-counterfeiting pattern on merchandise packaging, the anti-counterfeiting pattern and/or label pattern on merchandise packaging are random;
the label supplier verification server is further used for storing anti-counterfeiting patterns corresponding to the user-inputted identification code.

10. The system of claim 9, wherein the anti-counterfeiting label is printed with a verification password area for a verification password to be inputted when verifying authenticity of a merchandise with the anti-counterfeiting label through a server, a surface of the verification password area has a covering layer;
the label supplier verification server is further used for receiving a user-inputted verification password in the anti-counterfeiting label attached to the merchandise to be verified;
the label supplier verification server is used for determining whether the user-inputted identification code being prestored; if yes, then displaying on a user query page an anti-counterfeiting pattern corresponding to the user-inputted identification code and a prestored label pattern of an anti-counterfeiting label corresponding to the user-inputted identification code before being delivered to a merchandise supplier, specifically:
the label supplier verification server determines whether the user-inputted identification code being prestored and whether the verification password being correct, if the user-inputted identification code being prestored in the label supplier verification server and the verification password being correct, then displaying on a user query page an anti-counterfeiting pattern corresponding to the user-inputted identification code and a prestored label pattern of an anti-counterfeiting label corresponding to the user-inputted identification code before being delivered to a merchandise supplier; and the label supplier verification server records that the user-inputted identification code has been verified, and prompts when be verified again.
